(19) United States
(12) Patent Application Publication
(10) Pub. No.: US 2015/0302838 A1
(43) Pub. Date: Oct. 22, 2015

(54) ERGONOMIC GUITAR AND HARNESS

(71) Applicant: Polyvalor, Limited Partnership, Montreal (CA)

(72) Inventor: Philippe Lessard, Montreal (CA)

(21) Appl. No.: 14/688,529

(22) Filed: Apr. 16, 2015

Related U.S. Application Data
(60) Provisional application No. 61/980,213, filed on Apr. 16, 2014.

(51) Int. Cl. G10G 5/00

(52) U.S. Cl. CPC G10G 5/005

(57) ABSTRACT

A stringed musical instrument comprises a neck with a fingerboard. A body is connected to the neck such that the neck projects proximally away from the body, a bridge being located on the body with strings extending from the bridge over the fingerboard to an end of the neck, wherein: the stringed musical instrument has a playing orientation in which the neck, with a plane of the fingerboard being generally vertical, is at an angle ranging between 25 and 50 degrees from the horizon, at least a first strap connector positioned on a proximal end of the body is above the strings, and a center of mass of the stringed musical instrument is vertically aligned with the central strap connector at an angle within the range

### CROSS-REFERENCE TO RELATED APPLICATION

The present application claims priority on U.S. Provisional Application Ser. No. 61/980,213, filed on Apr. 16, 2014, and incorporated herein by reference.

### TECHNICAL FIELD

The application relates generally to stringed musical instrument of the guitar family and, more particularly, to an ergonomic guitar and harness for optimizing the comfort and effort of the guitarist when playing the instrument.

### BACKGROUND OF THE ART

Although many features of guitars have evolved significantly over the years, some guitars, and particularly some electric guitars, are still not optimal with respect to their form. This lack of ergonomic form can negatively affect the physical effort required to use the guitar and the discomfort felt by the guitarist.

For example, when the guitarist is standing, the entire weight of some guitars is generally supported by only one of the guitarist's shoulders. Over time, this can cause a significant disequilibrium in the guitarist's posture. Similarly, the neck of the guitar hanging from the shoulder of the guitarist is often oriented awkwardly, which forces the guitarist to play the guitar by placing her/his wrist in a state of hyper flexion. Furthermore, the support for the strumming hand on the body of the guitar often positions the elbow of this hand at an awkward elevation, which can cause tension to build in the corresponding shoulder and extension of the wrist when the guitarist is playing bass chords. In addition, the guitarist is often required to exert a constant force to balance or position the guitar so that it can be played comfortably.

Other ergonomic issues are also observed when the guitarist plays the guitar in a seated position. For example, the positioning of the guitar and the guitarist can require that the back exert a constant twisting or torsional force, in addition to the wrist problems mentioned above.

While it is possible for the guitarist to adapt to these discomforts, it is known that frequent users of guitars having such design issues can develop joint and muscle problems, as well as neuropathies.

### SUMMARY

In one aspect, there is provided a stringed musical instrument comprising: a neck with a fingerboard; a body being connected to the neck such that the neck projects proximally away from the body, a bridge being located on the body with strings extending from the bridge over the fingerboard to an end of the neck, wherein: the stringed musical instrument has a playing orientation in which: the neck, with a plane of the fingerboard being generally vertical, is at an angle ranging between 25 and 50 degrees from the horizon, at least a first strap connector positioned on a proximal end of the body is above the strings, and a center of mass of the stringed musical instrument is vertically aligned with the central strap connector at an angle within the range.

In another aspect, there is provided an ergonomic harness for suspending a guitar about the shoulders of a user, comprising: a belt portion terminating in opposed first and second ends and adapted to be worn about a waist of the user, the first and second ends being attachable to a body of the guitar, a line connects the first and second ends when attached to the body and is substantially perpendicular to a vertical central axis of the user upon the guitar being suspended about the shoulders of the user; and a shoulder portion attached to the belt portion for mounting about the shoulders of the user, the shoulder portion having a free third end being attachable to the body of the guitar, the third end when attached to the body lying substantially along the central axis and above the first and second ends upon the guitar being suspended about the shoulders of the user.

In a further aspect, there is provided a method for supporting a guitar on a user, comprising: suspending the guitar about at least the shoulders of the user with a harness; attaching the harness to opposite ends of a body of the guitar, the ends being aligned along a direction being substantially perpendicular to a vertical central axis of the user; and adjusting the harness with respect to at least the shoulders of the user to position a center of mass of the guitar in proximity to the vertical central axis of the user.

In yet a further aspect, there is provided a stringed musical instrument comprising: a neck with a fingerboard; a body being connected to the neck such that the neck projects proximally away from the body, a bridge being located on the body with strings extending from the bridge over the fingerboard to an end of the neck, the body having a main front surface upon which the bridge is connected, a main rear surface opposite the main front surface, wherein the main rear surface is concave, an axis of curvature of the main rear surface is adapted to align with a vertical central axis of a user in the playing orientation of the stringed musical instrument, and wherein a thickness between the main front surface and the main rear surface varies to define the concave.

### DESCRIPTION OF THE DRAWINGS

Reference is now made to the accompanying figures in which:

FIG. 1A is a perspective view of a guitar being held by a user in a seated position, according to an embodiment of the present disclosure, with the guitar in a playing orientation;

FIG. 1B is another perspective view of the guitar of FIG. 1 being held by a user in a standing position.

FIG. 2A is a perspective view of a playing surface of the guitar of FIG. 1; FIG. 2B is another perspective view of the playing surface of the guitar of FIG. 1;

FIG. 3A is a perspective view of a support surface of the guitar of FIG. 1; FIG. 3B is another perspective view of the support surface of the guitar of FIG. 1;

FIG. 4A is a perspective view of an ergonomic harness suspending a guitar about the shoulders of a user, according to another embodiment of the present disclosure, in a playing orientation of the guitar;

FIG. 4B is a perspective view of the harness of FIG. 4A freely suspending the guitar;

FIG. 4C is a perspective side view of the attachment of the harness of FIG. 4A to the guitar;

FIG. 4D is a perspective rear view of the attachment of the harness of FIG. 4A to the guitar;

FIG. 5A is a perspective view of the relationship between one of the wrists of the user and the guitar of FIG. 4A; and

FIG. 5B is a perspective view of the relationship between the other wrist of the user and the guitar of FIG. 4A.

### DETAILED DESCRIPTION

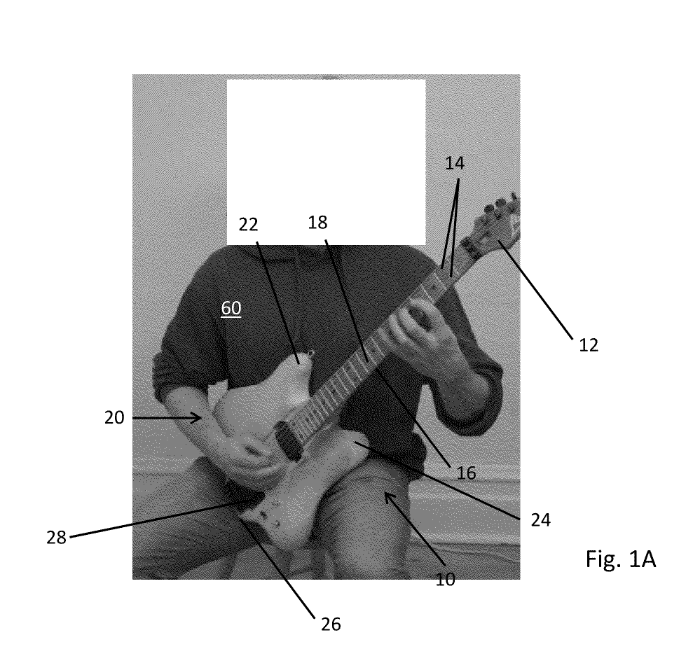

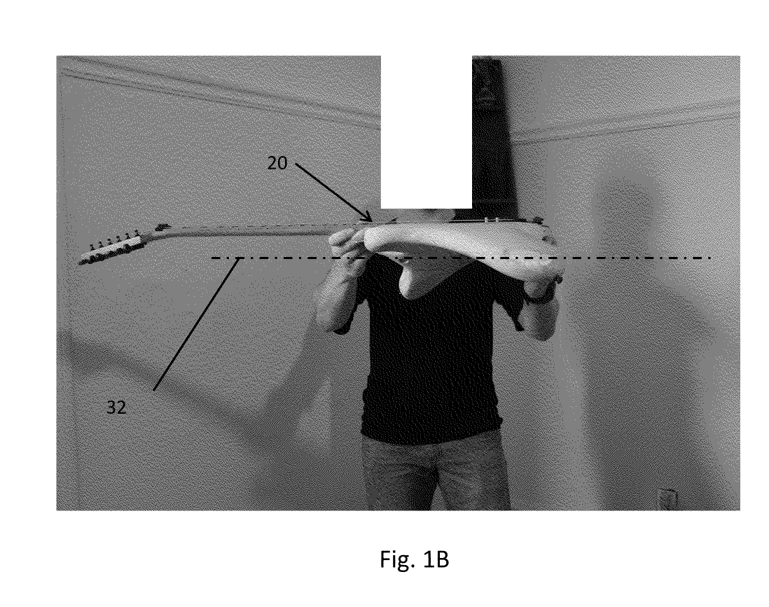

FIGS. 1A and 1B illustrates generally a guitar 10 being held by a user 60. Although shown as being an electric guitar 10, it will be appreciated that the guitar 10 can also be an acoustic, semi-acoustic, classical, bass guitar, or other such guitar 10. Similarly, although only embodiments of a “guitar” will be described herein for the purposes of concision, it will be appreciated that the guitar 10 can be any other similar musical instrument or chordophone which produces sound by vibrating tensioned strings, such as a bass guitar, etc, and that is played with its fingerboard being generally vertical, with a body of the instrument facing the player's torso. Similarly, the guitar 10 and/or its components can be contained in a custom-designed casing.

The guitar 10 has many of the conventional features and components associated with guitars 10. By way of example, these components can include, but are not limited to, a headstock 12 with tuning pegs for securing strings 14 thereto and adjusting their tension. They also include an elongated neck 16. The neck 16 has a fretboard or fingerboard 18 with or without corresponding frets (fretless) which extend along the length of the neck 16. The neck 16 extends from a first end which is connected to the headstock 12, and a second end which connects to the body 20, now discussed in greater detail.

The body 20 forms the corpus of the guitar 10 and is the other terminal for the strings 14 attached at the headstock 12. It provides structure to the guitar 10 and is largely determinative of the location of its center of mass, which is further discussed below. The fretboard 18 can extend from the second end of the neck along some portion of the body 20, as required.

The “archtop” embodiment of the body 20 shown in FIGS. 1A and 1B includes an upper horn 22, a lower horn 24, and a heel end 26. These features can be suitable locations for attachment points (a.k.a., strap connectors), as is further discussed below. The upper horn 22 and the lower horn 24 are shaped as horns by cutaways in the body 20. However, the body 20 may have a single lower horn 24, or may also be without horns. The body 20 also includes a bridge 28 (the expression “bridge” including the bridge and saddle assembly) which receive the strings 14. The body 20 can also include other components such as an acoustic hole, pickups, a pickguard, pickup switches, and nobs, whammy bar as part of the bridge 28 to name but a few examples. It will therefore be appreciated that the shape, configuration, and features of the body 20 disclosed herein are not limited to those of the particular embodiments shown in the figures. The body 20 has a playing surface 21 and a support surface 30 (i.e., back surface), both of which are now described in greater detail.

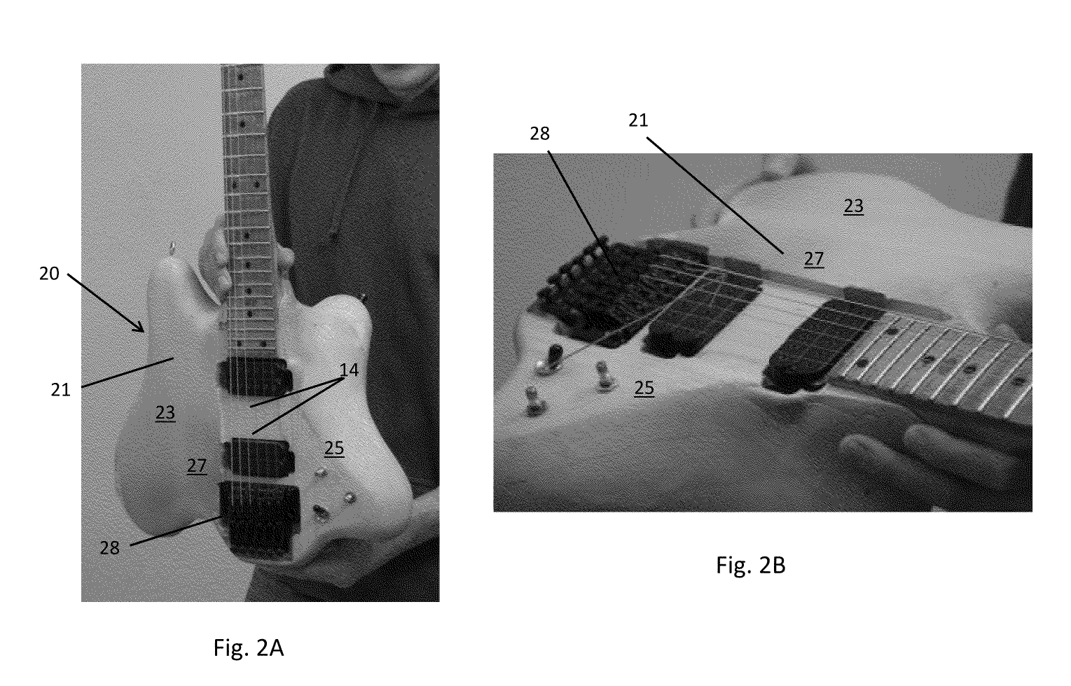

Referring to FIGS. 2A and 2B, the playing surface 21 can be any planar or arcuate area which forms the surface of the body 20 with which the user 60 interacts. As such, the playing surface 21 can take any suitable form. In the embodiment of FIGS. 2A and 2B, the bridge 28 and the plane in which the strings 14 lie form a barrier which separates the playing surface 21 into two separate regions: an upper region 23 and a lower region 25, with the expressions “upper” and “lower” being used as reference to a playing orientation of the guitar 10, i.e., with the plane of the fingerboard 18 being generally vertical as in FIG. 1A.

The upper region 23, shown as the area of the playing surface 21 left of the strings 14 in FIG. 2A, can be substantially planar over its area. A support region 27 can be located in a portion of the playing surface 21 just above the plane of the strings 14 and in proximity to the bridge 28 (when the guitar 10 is held in the orientation of FIG. 1A). From a playing surface 21 planar standpoint, the support region 27 is slightly elevated with respect to the mirror region below the strings 14, so as to be elevated to be closer to the plane of the strings 14, thereby providing a support for the wrist of the user 60 when placed thereon. When so placed, the wrist will be in a non-extended and neutral position when the strings are strummed or picked, thereby helping to reduce the stress experienced by the wrist of the user 60. The height of the support region 27 relative to the plane of the strings 14 can vary depending upon numerous factors such as the shape of the playing surface 21 and the type of guitar 10. In some instances, the height can be between a planar relation with the strings 14 (i.e., 0 mm) to about 4 mm below the plane of the strings 14. Such a configuration of at least part of the upper region 23 helps to support the wrist, and also allows for the user 60 to employ certain playing techniques, such as “palm muting”.

The lower region 25, shown as the area of the playing surface 21 to the right of the strings 14 in FIG. 2A, can also be substantially planar. The lower region 25 is at a lower height or elevation with respect to the plane of the strings 14 and to the support region 27 so that the user 60 can strum or pick the strings 14 without encountering obstacles. To facilitate such functionality, the lower region 25 may include a receding portion which drops away from the playing surface 21.

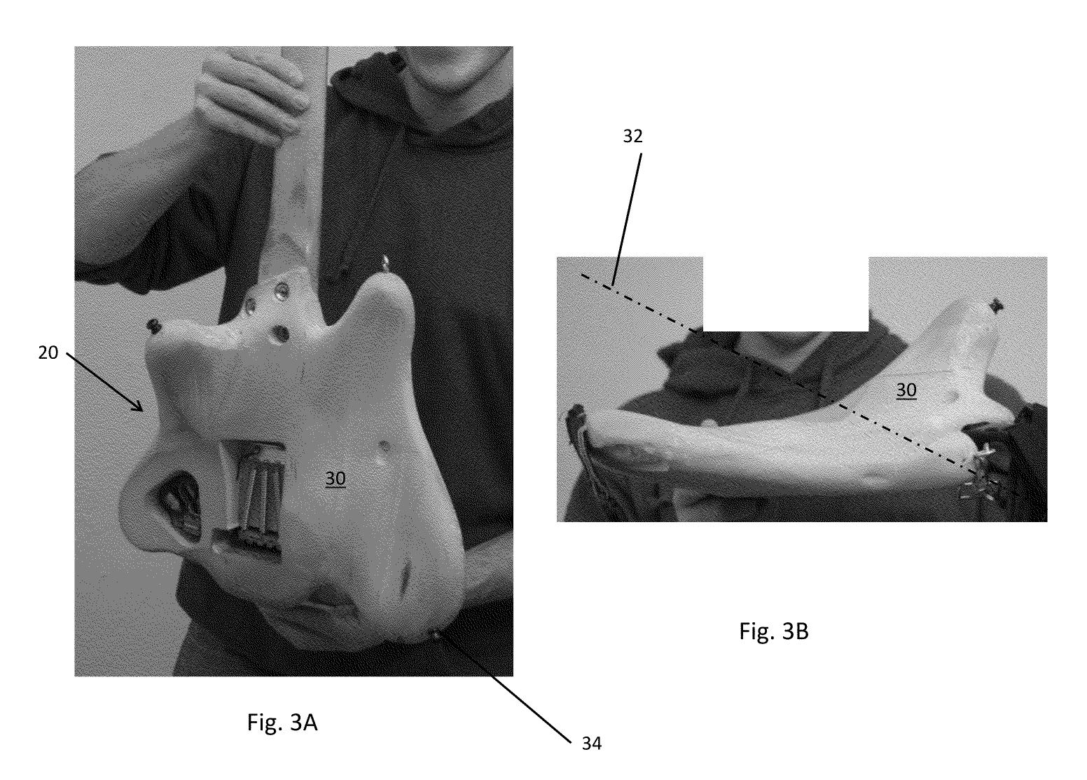

Referring to FIGS. 3A and 3B, the support surface 30 (a.k.a., main rear surface) is disposed opposite the playing surface 21 and is the area of the guitar 10 which faces toward the user 60 when the guitar 10 is used. It can include cavities or depressions for housing components of the guitar 10. The support surface 30 is curved concavely about a curvature axis 32, with the curvature exacerbated by a curve of the lower horn 24 and a curving distal end of the guitar 10. The term “concave” refers to the orientation of the curvature of the support surface 30, in that the curve of the support surface 30 opens towards and faces the user 60 when the guitar 10 is being used in a playing orientation. The shape of the support surface 30, and thus of the guitar 10, can be adapted to the particular form of the user 60 for which it is intended so as to maximise contact with the torso of the user 60. It will therefore be appreciated that the shape of the curve of the support surface 30, as well as its degree of curvature, can vary depending on the intended user 60 of the guitar 10. As such, the body 20 and the guitar 10 can be advantageously custom designed and manufactured for the user 60 in question. The curvature results from a variation of the thickness of the body 20, i.e., in a direction generally normal to a plane of the strings 14. In other words, the curvature of the support surface 30 is greater than the curvature of the playing surface 21. The playing surface 21 is generally flat, or archtop, whereas the support surface 30 has a substantially curve, and thus a greater radius of curvature.

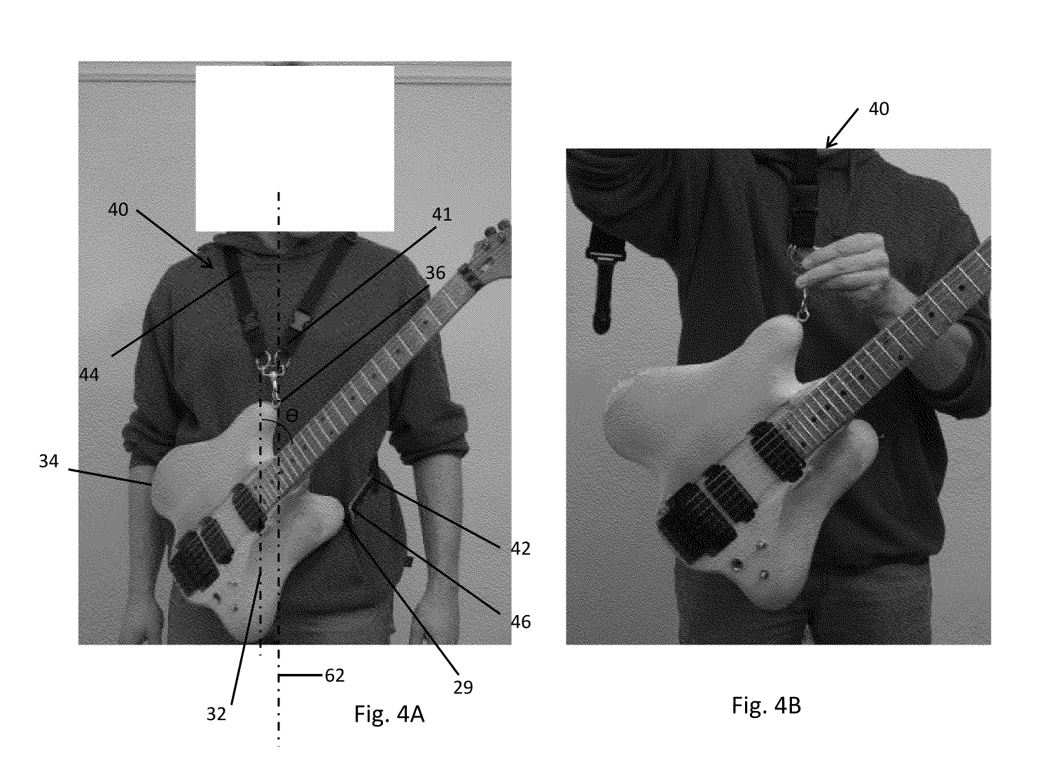

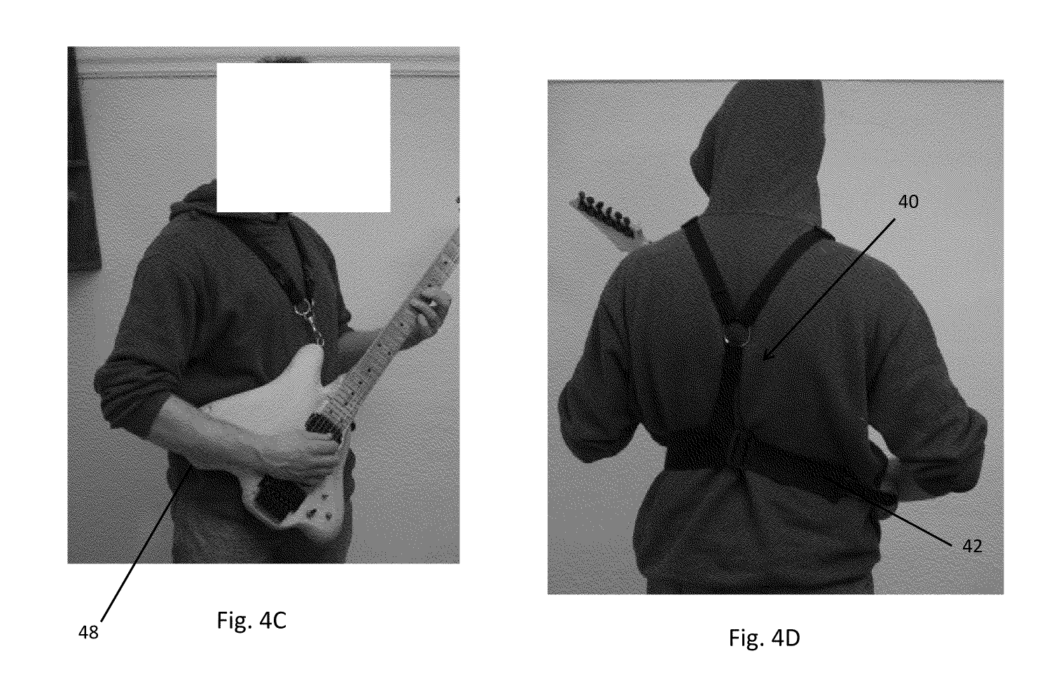

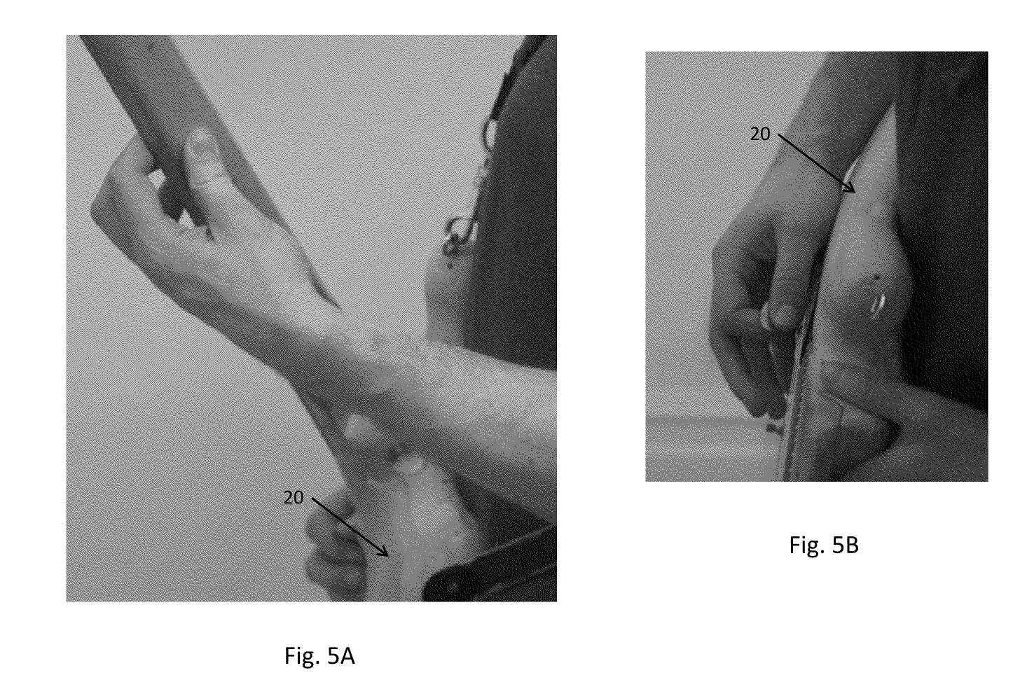

Such a curvature of the support surface 30 allows the user 60 to bring the guitar 10 closer to her/his body so that the curvature axis 32 of the body 20 can be parallel, aligned and/or coincident with a vertical central axis 62 (a.k.a., cranial-caudal axis) of the user 60 when the guitar 10 is being used (see FIG. 4A). The vertical central axis 62 of the user 60 can be any straight line which extends vertically from the user's 60 head to her/his feet, runs through the user's 60 center of mass, and forms an axis of symmetry for the user's 60 body. In most instances, the central axis 62 is parallel to, and collinear with, the user's 60 spine. Such proximity and alignment of the axes 32,62 helps to reduce the discomfort experienced by the user 60, whether standing or sitting, and the effort she/he must deploy when using the guitar 10, in at least the following two ways.

First, the proximity of the center of mass of the guitar 10 (which is typically located somewhere on the body 20) to the user's spine or central axis 62 which is facilitated by the curvature of the support surface 30 brings the guitar's 10 center of mass closer to the user's center of mass. In reducing the thickness distance (i.e. toward and away from the body) between these two centers of mass, the corresponding moment between these two centers is also reduced. This reduction in moment lowers and/or eliminates the constant effort the user 60 must employ to balance the guitar 10.

Second, the alignment of the curvature axis 32 with the central axis 62 reduces the lateral distance (i.e. between the left and right sides of the user 60) separating them, and thus the corresponding lateral moment generated by said distance. This reduction in moment also lowers and/or eliminates the constant effort the user 60 must employ to balance the guitar 10. As such, it can be appreciated that the term “align”, when used to describe the relationship between the curvature axis 32 and the central axis 62, is not limited to perfect collinearity between the two axes 32,62. Indeed, the axes 32,62 can be slightly offset and/or at angle from one another and still help to lower and/or eliminate the lateral moment.

Referring to FIGS. 4A to 4D, an ergonomic harness 40 can be used with the above-described guitar 10 in order to suspend the guitar 10 around the shoulders of the user 60 and support its weight. In so doing, the harness 40 advantageously distributes the weight of the guitar 10 relatively evenly between the user's 60 shoulders, thereby helping to lower and/or eliminate the stress and posture problems associated with conventional straps which only support the weight of the guitar 10 on one shoulder. As will be further explained below, the harness 40 advantageously helps to position the guitar 10 in a suitable playing position with respect to the user 60 so that she/he is able to play the guitar 10 without experiencing the known stress and neuropathies described above. The harness 40 can be any suitable arrangement of interconnected and attachable straps. It has a belt portion 42 and a shoulder portion 44, both of which will now be described in greater detail.

The belt portion 42 can be secured around or near the waist of the user 60. In so doing, the belt portion 42 helps to reduce and/or eliminate the torsional or twisting work performed by the back when conventional straps are used to suspend the guitar from only one of the user's 60 shoulders. The belt portion 42 has a first end 46 and an opposed second end 48 which are fitted with suitable connection devices in order to attach to opposed ends of the body 20 of the guitar 10. More specifically, the first end 46 can connect to a corresponding first attachment point 29 located on the periphery of the body 20. Similarly, the second end 48 can connect to a corresponding second attachment point 34 also located on the periphery of the body 20. Each attachment point 29,34 can be any suitable device such as a hook, button, or other mechanical attachment. When the guitar 10 is suspended from the shoulders of the user, the first and second attachment points 29,34 are at roughly the same height from the ground, and thus are substantially horizontally aligned such that a line can be traced between them. This line will be substantially perpendicular to the curvature axis 32 of the support surface 30. The term “substantially” encompasses suitable deviations from the absolute horizontal or perpendicular which do not significantly affect the moments described above.

The shoulder portion 44 can be permanently or removably attached to the belt portion 42. The shoulder portion 44 allows the guitar 10 to be suspended about the shoulders of the user 60 such that its weight is supported approximately equally between both shoulders. A free third end 41 of the shoulder portion 44 can connect to a corresponding third attachment point 36 located on the periphery of the body 20. The connecting of the third end 41 to the third attachment point 36 allows the guitar 10 to be suspended vertically. When so suspended or in use, the third attachment point 36 lies along, or in proximity to, the curvature axis 32 and the central axis 62, and is positioned above the first and second attachment points 29,34 on the body 20. The third attachment point 36 therefore allows the center of mass of the body 20 to align with the central axis 62 of the user 60.

In light of the preceding, it can be appreciated that the strap portion 44 of the harness 40 helps to distribute the weight of the guitar 10 evenly between the shoulders of the user 60, and further helps to align the center of mass of the body 20 with the central axis 62 of the user 60. It can be further appreciated that the belt portion 42 helps to secure the guitar 10 to the user 60 by reducing and/or preventing relative side-to-side motion, and further assists in bringing the guitar's 10 center of mass closer to the user's 60 center of mass. Such functionality is particularly applicable when the user 60 is playing the guitar 10 in a standing position.

Such an advantageous positioning of the guitar 10 relative to the body encourages an ergonomic positioning of the arms, shoulders, elbows, and wrists of the user 10. Specifically, and referring to FIG. 4C, the upper arm and forearm of each arm can be comfortably angled at their elbow at around 90°, which places the upper arm and forearm in a relatively stress-free and neutral position. Furthermore, the back of the user 60 can be kept facing straight, and is not required to twist in order to maintain the guitar 10 in the correct position. In addition, the support of the weight of the guitar 10 over both shoulders or close to the user's 60 chest encourages the user 60 to adopt a better posture when playing the guitar 10.

When suspended by the harness 40 about the shoulders of the user 60, the neck 16 of the guitar 10 forms a neck angle θ with respect to the curvature axis 32 and/or the central axis 60, as shown in FIG. 4A, in a playing orientation of the guitar 10. Relative to the horizon, the neck angle is therefore 90−θ. The term “suspended” refers to the natural position at which the guitar 10 falls freely under gravity alone when hung from the third attachment point 36. The neck angle θ can vary depending on numerous factors such as the shape of the body 20, the type of guitar 10 being used, and the intended user 60. In some instances, the neck angle relative to the horizon does not exceed about 50°, and is in a first embodiment between 25° and 50°. In another embodiment, the neck angle ranges between 28° and 48°. Further optionally, the neck angle θ can be between about 40° and about 42°. It can thus be appreciated that the harness 40 and the features of the guitar 10 described above cooperate together to help naturally position the neck 16 at an orientation which facilitates use of the guitar 10 by the user 60. A feature of the guitar 10 is that, when it is in the playing orientation with the neck angle within the predetermined range relative to the horizon, the third attachment point 36 is at some point vertically aligned with the center of mass of the guitar 10. When this is the case, the guitar 10 will be in equilibrium, and therefore the player will not have to oppose a force against rotation in angle θ to maintain the guitar 10 in its playing orientation. As for rotation about a longitudinal axis of the guitar 10, and an axis normal to the guitar 10, the connection of the guitar 10 by its first and second ends 46,48 secures the guitar 10 to the player's torso, whereby the player has little or no force to provide to maintain the guitar 10 in the playing orientation.

According to another aspect, there is provided a method for supporting the guitar 10 on the user 60. The method includes suspending the guitar 10 about at least the shoulders of the user 60 with a harness 40, such as the one described above. The method also includes attaching the harness 40 to opposite ends of the body 20, such as the first and second ends 46,48 of the guitar 10. These ends 46,48 are roughly the same height, and are aligned along a direction which is substantially perpendicular to the vertical central axis 62 of the user 60. The method also includes adjusting the harness 40 with respect to at least the shoulders of the user 60 in order to position a center of mass of the guitar 10 in proximity to the vertical central axis 62 of the user 10. This allows the guitar 10 to be placed in a suitable playing position for the user 60.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

Therefore, a method for supporting the guitar 10 on a user, comprises: suspending the guitar 10 about at least the shoulders of the user with the harness 40; attaching the harness 40 to opposite ends of a body 20 of the guitar 10, the ends being aligned along a direction being substantially perpendicular to the vertical central axis 62 of the user; and adjusting the harness 40 with respect to at least the shoulders of the user to position a center of mass of the guitar in proximity to the vertical central axis 62 of the user.

1. A stringed musical instrument comprising:
a neck with a fingerboard;
a body being connected to the neck such that the neck projects proximally away from the body, a bridge being located on the body with strings extending from the bridge over the fingerboard to an end of the neck, wherein:
the stringed musical instrument has a playing orientation in which:
the neck, with a plane of the fingerboard being generally vertical, is at an angle ranging between 25 and 50 degrees from the horizon,
at least a first strap connector positioned on a proximal end of the body is above the strings, and
a center of mass of the stringed musical instrument is vertically aligned with the central strap connector at an angle within the range.

2. The stringed musical instrument according to claim 1, further comprising a second strap connector positioned at a distal end of the body, and a third strap connector positioned at a proximal end of the body and below the strings in the playing orientation.

3. The stringed musical instrument according to claim 2, wherein the body has a pair of horns in the proximal end, the first strap connector being on one of the horns, the third strap connector being on the other of the horns.

4. The stringed musical instrument according to claim 2, wherein an axis passing through the second strap connector and the third strap connector is parallel to the horizon in the playing orientation of the stringed musical instrument.

5. The stringed musical instrument according to claim 1, wherein the body has a main front surface upon which the bridge is connected, a main rear surface opposite the main front surface, wherein the main rear surface is concave.

6. The stringed musical instrument according to claim 5, wherein an axis of curvature of the main rear surface is adapted to align with a vertical central axis of a user in the playing orientation of the stringed musical instrument.

7. The stringed musical instrument according to claim 5, further comprising a horn for accessing a distal part of the fingerboard in the playing orientation, the horn curving rearwardly as part of the main rear surface.

8. The stringed musical instrument according to claim 7, wherein a distal end of the body curves rearwardly as part of the main rear surface, with a second strap connector is positioned at the distal end, and a third strap connector is positioned at said horn.

9. The stringed musical instrument according to claim 8, wherein an axis passing through the second strap connector and the third strap connector is parallel to the horizon in the playing orientation of the stringed musical instrument.

10. The stringed musical instrument according to claim 1, wherein the main front surface has subsurfaces on opposite sides of the strings, between the bridge and a distal end of the neck, the subsurface above the strings in the playing orientation being in a plane raised relative to a plane of the surface below the strings in the playing orientation.

11. The stringed musical instrument according to claim 10, wherein the subsurface above the strings in the playing orientation is locally substantially coplanar with the strings.

12. The stringed musical instrument according to claim 1, wherein the stringed musical instrument is one of a guitar and a bass guitar.

13. The stringed musical instrument according to claim 1, wherein the angle ranges between 28 and 48 degrees from the horizon.

14. A stringed musical instrument comprising:
a neck with a fingerboard;
a body being connected to the neck such that the neck projects proximally away from the body, a bridge being located on the body with strings extending from the bridge over the fingerboard to an end of the neck, the body having a main front surface upon which the bridge is connected, a main rear surface opposite the main front surface, wherein the main rear surface is concave, an axis of curvature of the main rear surface is adapted to align with a vertical central axis of a user in the playing orientation of the stringed musical instrument, and wherein a thickness between the main front surface and the main rear surface varies to define the concave.

15. The stringed musical instrument according to claim 14, further comprising at least a first strap connector positioned on a proximal end of the body above the strings in the playing orientation, a second strap connector positioned at a distal end of the body, and a third strap connector positioned at a proximal end of the body and below the strings in the playing orientation, wherein an axis passing through the second strap connector and the third strap connector is perpendicular to the axis of curvature of the stringed musical instrument.

16. The stringed musical instrument according to claim 14, further comprising a horn for accessing a distal part of the fingerboard in the playing orientation, the horn curving rearwardly as part of the main rear surface.

17. The stringed musical instrument according to claim 16, wherein a distal end of the body curves rearwardly as part of the main rear surface, with a strap connector is positioned at the distal end, and another strap connector is positioned at said horn.

18. The stringed musical instrument according to claim 14, wherein the main front surface has subsurfaces on opposite sides of the strings, between the bridge and a distal end of the neck, the subsurface above the strings in the playing orientation being in a plane raised relative to a plane of the surface below the strings in the playing orientation.

19. The stringed musical instrument according to claim 18, wherein the subsurface above the strings in the playing orientation is locally substantially coplanar with the strings.

20. The stringed musical instrument according to claim 14, wherein the stringed musical instrument is one of a guitar and a bass guitar.
